(19) United States
(12) Patent Application Publication
(10) Pub. No.: US 2025/0252634 A1
(43) Pub. Date: Aug. 7, 2025

(54) CONTENT CREATION SCREEN PROVISION METHOD AND SYSTEM THEREOF

(71) Applicant: Samsung SDS Co., Ltd., Seoul (KR)

(72) Inventors: Young Hyun CHOI, Seoul (KR); Ji Yeon LEE, Seoul (KR); In Pyo KIM, Seoul (KR); Kyung Eun HWANG, Seoul (KR); Bo Young PARK, Seoul (KR); Seung Jin KIM, Seoul (KR)

(73) Assignee: Samsung SDS Co., Ltd., Seoul (KR)

(21) Appl. No.: 19/046,806

(22) Filed: Feb. 6, 2025

(30) Foreign Application Priority Data
Feb. 6, 2024 (KR) 10-2024-0017795
Apr. 25, 2024 (KR) 10-2024-0055462

(51) Int. Cl. G06T 11/60; G06F 3/0486; G06F 3/0488

(52) U.S. Cl. CPC G06T 11/60; G06F 3/0486; G06F 3/0488; G06T 2200/24

(57) ABSTRACT

A content creation screen provision method and system thereof are provided. The method may include receiving a predefined first gesture for a first plurality of objects displayed on a content creation screen of the computing device, displaying the first plurality of objects in a prompt input area on the content creation screen, transmitting, to a service server, a first prompt generation request for creating content related to the first plurality of objects in response to a third gesture for content creation, receiving first content generated by generative artificial intelligence based on a first prompt input from the service server, displaying the first content on the content creation screen, receiving second content generated by the generative AI based on a second prompt input from the service server, and displaying the second content on the content creation screen.

### CROSS-REFERENCE TO RELATED APPLICATIONS

This application claims priority from Korean Patent Application No. 10-2024-0017795 filed on Feb. 6, 2024, and Korean Patent Application No. 10-2024-0055462 filed on Apr. 25, 2024, in the Korean Intellectual Property Office, and all the benefits accruing therefrom under 35 U.S.C. 119, the contents of which in its entirety are herein incorporated by references.

### BACKGROUND

### 1. Field

The present disclosure relates to a content creation screen provision method and system, and more specifically, to a content creation screen provision method for providing a screen that allows a user to conveniently create content and a system to which the content creation screen provision method is applied.

### 2. Description of the Related Art

According to conventional LL text-based prompt input methods, users are required to input various types of information, such as images, videos, and text, in text form only. Consequently, it is difficult to obtain refined deliverables that combine different types of information.

In addition, existing prompt input methods only allow sequential, time-series inputs. As a result, when a large amount of accumulated information exists, users may spend significant time searching for specific prompts. Furthermore, modifying outputs generated by generative artificial intelligence (AI) involves the inconvenience of re-entering previously generated outputs.

Moreover, in tasks where multiple users collaborate to produce videos or other content using various types of information, challenges in communication arise due to geographical separation or time zone differences between team members. Such challenges may lead to inconsistent work, project delays, resource waste, and reduced quality of deliverables.

Therefore, there is a need for a technology that supports users in conveniently inputting various types of information into prompt input areas and enhances the efficiency of collaborative work performed by multiple users.

### SUMMARY

An objective of the present disclosure is to provide a method and system that enable a user to easily input multi-type information comprising various types of data into a prompt input area.

Another objective of the present disclosure is to provide a method and system that allow a user to easily edit outputs generated by generative artificial intelligence (AI).

Yet another objective of the present disclosure is to provide a method and system that enable multiple users to effectively perform collaborative work.

The objectives of the present disclosure are not limited to those mentioned above, and other objectives not explicitly stated will be clearly understood by those skilled in the art based on the following description.

According to an aspect of the present disclosure, there is provided A content creation screen provision method performed by a computing device. The method may comprise receiving a predefined first gesture for a first plurality of objects displayed on a content creation screen of the computing device, displaying the first plurality of objects in a prompt input area on the content creation screen in response to the first gesture, transmitting, to a service server, a first prompt generation request for creating content related to the first plurality of objects in response to a third gesture for content creation, wherein the first prompt generation request includes first data regarding the first plurality of objects, receiving first content generated by generative artificial intelligence (AI) based on a first prompt input from the service server, displaying the first content on the content creation screen, receiving a predefined second gesture for at least one object among the first plurality of objects displayed in the prompt input area, wherein the second gesture is applied within the prompt input area, displaying a second plurality of objects in the prompt input area on the content creation screen in response to the second gesture, wherein the second plurality of objects is determined based on the second gesture, transmitting, to the service server, a second prompt generation request in response to the third gesture, wherein the second prompt generation request includes second data regarding the second plurality of objects, receiving second content generated by the generative AI based on a second prompt input from the service server, and displaying the second content on the content creation screen.

In some embodiments, the first plurality of objects includes graphic objects representing images, videos, text, and audio information.

In some embodiments, the first gesture includes: an action of moving a first object to a location of a second object while maintaining a first long-tap input on the first object; an action of moving the second object to the prompt input area while maintaining a second long-tap input on the second object; and an action of releasing the second long-tap input in the prompt input area.

In some embodiments, the first and second objects are graphic objects representing different attributes of information.

In some embodiments, the method may further comprise before the transmitting the first prompt generation request to the service server, receiving a user request related to content creation, wherein the first prompt generation request further includes data regarding the user request.

In some embodiments, the second gesture includes an action of moving a first object out of the prompt input area while maintaining a long-tap input on the first object. In some embodiments, the second gesture further includes an action of moving a second object with a same attribute as the first object into the prompt input area while maintaining a long-tap input on the second object, and the second object is a graphic object displayed outside the prompt input area.

In some embodiments, the second gesture further includes an action of moving a second object with a same attribute as the first object into the prompt input area while maintaining a long-tap input on the second object, and the second object is a graphic object displayed outside the prompt input area.

In some embodiments, the second gesture includes: an action of moving a first object to a location of a second object while maintaining a first long-tap input on the first object in a first area within the prompt input area; and an action of moving the second object to a second area within the prompt input area while maintaining a second long-tap input on the second object, and the first and second areas are displayed at different locations.

In some embodiments, the method may further comprise after the displaying the second content on the content creation screen, receiving a predefined fourth gesture for the second content; and transmitting, to the service server, a third prompt generation request in response to the fourth gesture, wherein the third prompt generation request includes second data regarding the second content and user edit request data regarding the second content. In some embodiments, the fourth gesture is applied within an area on the content creation screen where the second content is displayed.

According to another aspect of the present disclosure, there is provided a content creation screen provision method performed by one or more computing devices. The method may comprise receiving multiple data transmitted by the one or more computing devices used for collaborative work by multiple users, transmitting, to a service server, a first prompt generation request for creating content corresponding to the collaborative work based on the multiple data, receiving first content generated by generative artificial intelligence (AI) based on a first prompt input from the service server and displaying the first content on content creation screens of the one or more computing devices, receiving, by a first computing device, a predefined first gesture for at least one object among a first plurality of objects displayed on a content creation screen of the first computing device, wherein the first plurality of objects corresponds to graphic objects representing the multiple data, displaying, by the first computing device, a second plurality of objects in a prompt input area on the content creation screen of the first computing device in response to the first gesture, wherein the second plurality of objects is determined based on the first gesture, transmitting, to the service server, a second prompt generation request in response to a second gesture for content creation, wherein the second prompt generation request includes data regarding the second plurality of objects, receiving second content generated by the generative AI based on a second prompt input from the service server and displaying the second content and the second plurality of objects on the content creation screens of the one or more computing devices, receiving, by a second computing device, a predefined third gesture for at least one object among the second plurality of objects displayed on a content creation screen of the second computing device, displaying, by the second computing device, a third plurality of objects in a prompt input area on the content creation screen of the second computing device in response to the third gesture, wherein the third plurality of objects is determined based on the third gesture, transmitting, to the service server, a third prompt generation request in response to the second gesture for content creation, wherein the third prompt generation request includes data regarding the third plurality of objects; and receiving third content generated by the generative AI based on a third prompt input from the service server and displaying the third content and the third plurality of objects on the content creation screens of the one or more computing devices.

In some embodiments, the multiple data includes files in which image, video, text, and audio materials are stored, and the files are displayed as visualized graphic objects on screens of the one or more computing devices.

In some embodiments, the first gesture includes an action of moving a first object out of the prompt input area on the content creation screen of the first computing device while maintaining a long-tap input on the first object.

In some embodiments, the first gesture further includes an action of moving a second object with a same attribute as the first object into the prompt input area while maintaining a long-tap input on the second object.

In some embodiments, the method may comprise further after the displaying the third content and the third plurality of objects on the content creation screens of the one or more computing devices, receiving a predefined fourth gesture for the third content displayed on a content creation screen of a third computing device, and transmitting, to the service server, a fourth prompt generation request in response to the fourth gesture, wherein the fourth prompt generation request includes third data regarding the third content and user edit request data regarding the third content.

In some embodiments, the fourth gesture is applied within an area on the content creation screen of the third computing device where the third content is displayed.

According to another aspect of the present disclosure, there is provided a content creation screen provision system. The system may comprise one or more processors; and a memory storing one or more computer programs executed by the one or more processors; wherein the one or more computer programs include instructions for operations of: receiving a predefined first gesture for a first plurality of objects displayed on a content creation screen of a computing device; displaying the first plurality of objects in a prompt input area on the content creation screen in response to an input of the first gesture; transmitting, to a service server, a first prompt generation request for creating content related to the first plurality of objects in response to a third gesture for content creation, wherein the first prompt generation request includes first data regarding the first plurality of objects; receiving first content generated by generative artificial intelligence (AI) based on a first prompt input from the service server; displaying the first content on the content creation screen; receiving a predefined second gesture for at least one object among the first plurality of objects displayed in the prompt input area, wherein the second gesture is applied within the prompt input area; displaying a second plurality of objects in the prompt input area on the content creation screen in response to an input of the second gesture, wherein the second plurality of objects is determined based on the second gesture; transmitting, to the service server, a second prompt generation request in response to the third gesture for content creation, wherein the second prompt generation request includes second data regarding the second plurality of objects; receiving second content generated by the generative AI based on a second prompt input from the service server; and displaying the second content on the content creation screen.

According to the forementioned and other embodiments of the present disclosure, graphic objects containing various attributes of data (e.g., images, audio, text, video) can be selected at once to create various combinations of prompts, and by creating content based on those prompts, user convenience and satisfaction can be improved.

Additionally, a user can select multiple objects containing various attributes of data at once through a predefined gesture. By integrating with a generative AI model, optimal content that best meets the user's needs can be created, thereby effectively improving user convenience and satisfaction.

Also, a content editing function that minimize user operations through a predefined gesture is provided, thereby enhancing user convenience and satisfaction.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a flowchart illustrating a content creation screen provision method according to an embodiment of the present disclosure;

FIG. 2 is an exemplary flowchart illustrating a content creation screen provision method according to some embodiments of the present disclosure;

FIG. 3 is a diagram for explaining some operations illustrated in FIG. 1;

FIG. 4 is a diagram for explaining some operations illustrated in FIG. 1;

FIG. 5 is a diagram for explaining some operations illustrated in FIG. 1;

FIG. 6 is a flowchart illustrating a content creation screen provision method according to another embodiment of the present disclosure;

FIG. 7 is a diagram for explaining some operations illustrated in FIG. 6;

FIG. 8 is a diagram for explaining some operations illustrated in FIG. 6; and

FIG. 9 is a hardware configuration diagram of a content creation screen provision system according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

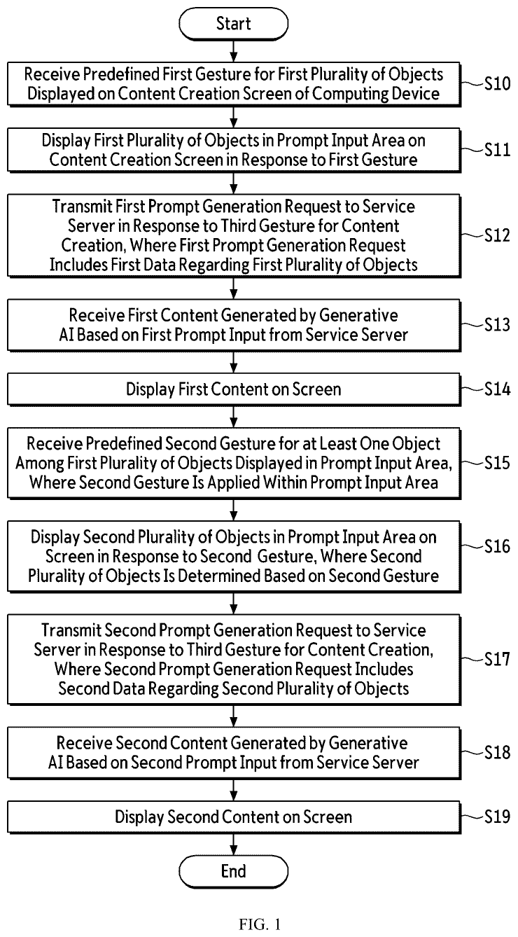

FIG. 1 is a flowchart illustrating a content creation screen provision method according to an embodiment of the present disclosure. However, it is to be understood that the embodiment of FIG. 1 is merely a preferred embodiment for achieving the objectives of the present disclosure, and certain steps may be added or deleted as needed.

Specifically, FIG. 1 illustrates steps/operations of a method performed by a user terminal (i.e., a computing device). Therefore, in the following description, if the subject performing a particular step/operation is not specified, it is to be understood that the particular step/operation is performed by the user terminal.

The user terminal may be a device such as a mobile phone, smartphone, tablet, laptop PC, or desktop PC. For ease of understanding, the following description will assume that the user terminal is a desktop PC, and the content creation screen provided to the user is displayed on the screen of the desktop PC.

As illustrated in FIG. 1, the content creation screen provision method according to an embodiment of the present disclosure may start with step S10, in which a computing device (i.e., a user terminal) receives a predefined first gesture input from a user for a first plurality of objects displayed on a content creation screen. Thereafter, in step S11, the computing device (i.e., the user terminal) may display the first plurality of objects in a prompt input area on the content creation screen in response to the first gesture.

The content creation screen may include a web page area 30a where web pages, programs, or applications displaying various data referenced for creating content desired by the user are displayed, and a prompt input area 30b where prompts for creating the desired content can be entered by the user. Additionally, the first plurality of objects may be graphic objects that include one or more data necessary for creating the desired content. Specifically, the first plurality of objects may refer to graphic objects representing any of images, videos, text, and audio information.

The first gesture may refer to a user-defined action for selecting a plurality of objects and generating prompts using the selected objects or a combination of such user-defined actions. For example, the first gesture may include an action of moving a first object to the location of a second object while maintaining a long-tap input on a first object displayed on the content creation screen, an action of moving the second object into the prompt input area while maintaining a long-tap input on the second object, and an action of releasing the long-tap input in the prompt input area. Here, the first object and the second object may be graphic objects representing different attributes of information.

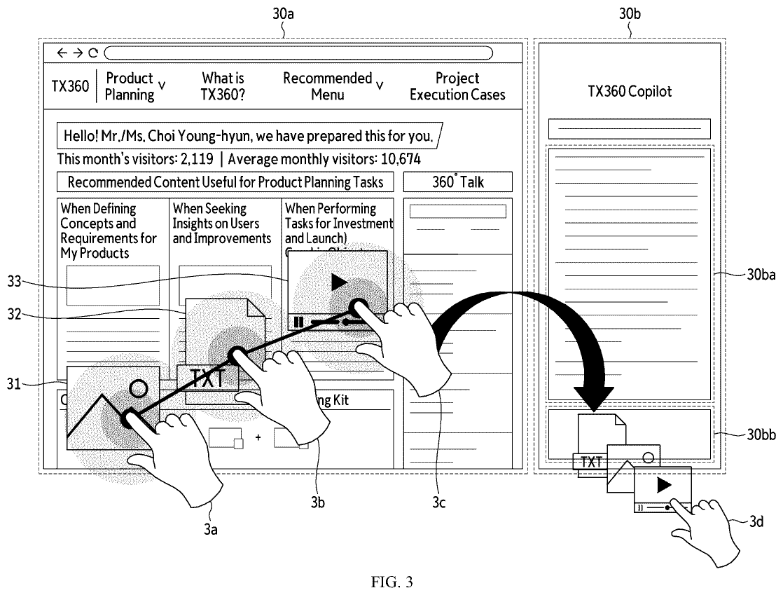

A first gesture according to an embodiment of the present disclosure will hereinafter be explained with reference to FIG. 3. FIG. 3 is a diagram for explaining some operations (i.e., steps S10 and S11) illustrated in FIG. 1.

Referring to FIG. 3, the content creation screen displayed on the user terminal may include a web page area 30a that displays various data referenced for creating the desired content and the prompt input area 30b where prompts for creating the desired content may be entered.

The prompt input area 30b may include a first area 30ba where completed prompts are displayed and a second area 30bb where prompts being entered by the user are displayed. Specifically, the first area 30ba may display prompts that have been completed and input to a generative artificial intelligence (AI) model through a service server. On the other hand, the second area 30bb may display prompts currently being entered by the user, which are yet to be sent to the service server or input to the generative AI model.

As illustrated in FIG. 3, the content creation screen may display a plurality of objects containing various attributes of data. For example, the content creation screen may display a first object 31 representing image data, a second object 32 representing text data, and a third object 33 representing video data. The user may input a predefined gesture for the first plurality of first objects (31, 32, and 33) displayed on the content creation screen, and in response to the predefined gesture, the first plurality of objects (31, 32, and 33) may be displayed in the prompt input area 30b on the content creation screen.

The area where the first plurality of objects (31, 32, and 33) is displayed and the user's gesture is input may refer to the web page area 30a within the content creation screen where various data is displayed. The area where the first plurality of objects (31, 32, and 33) is displayed in response to the user's gesture may refer to the second area 30bb within the prompt input area 30b.

As illustrated in FIG. 3, the user may perform a long-tap input on the first object 31, move the first object 31 to the location of the second object 32 while maintaining the long-tap input on the first object 31, and then perform a long-tap input on the second object 32. At this time, the first object 31 may be displayed overlapping the location of the second object 32, indicating that both the first and second objects 31 and 32 have been selected together.

Additionally, the user may move the second object 32 to the location of the third object 33 while maintaining the long-tap input on the second object 32 and then perform a long-tap input on the third object 33. At this time, the first and second objects 31 and 32 may both be displayed overlapping the position of the third object 33, indicating that the first, second, and third objects 31, 32, and 33 have all been selected.

Thereafter, the user may move the third object 33 to the prompt input area 30b while maintaining the long-tap input on the third object 33 and release the long-tap input on the third object 33 within the prompt input area 30b. When the long-tap input is released, the first, second, and third objects 31, 32, and 33 may be displayed in the prompt input area 30b. Then, if a predefined gesture for content creation is input by the user, a prompt for creating content related to the first, second, and third objects 31, 32, and 33 may be generated.

That is, the user may input a predefined gesture into the user terminal to select a plurality of graphic objects containing various attributes of data displayed on the content creation screen (e.g., web page screen) at once and move the selected graphic objects to the prompt input area. Through the predefined gesture, a prompt for creating content related to the selected graphic objects may be created.

Accordingly, various combinations of prompts can be generated by selecting graphic objects containing various attributes of data (e.g., images, audio, text, videos) at once, and content can be created based on the generated prompts, thereby enhancing user convenience and satisfaction.

As illustrated in FIG. 3, the prompt input area 30b may be displayed within the content creation screen on the user terminal, but the present disclosure is not limited thereto. That is, an area where one or more objects containing data for content creation are displayed may also be referred to as the content creation screen, and the prompt input area 30b may refer to a separate, distinct area from the content creation screen. In this case, the content creation screen and the prompt input area 30b may be displayed as separate pop-up windows.

Additionally, it is to be understood that the predefined first gesture illustrated in FIG. 3 is merely exemplary and is not limiting. That is, the user's first gesture may include various predefined actions for selecting multiple objects at once and inserting the selected objects into the prompt input area 30b.

Referring back to FIG. 1, in step S12, the computing device (i.e., the user terminal) may transmit a first prompt generation request to a service server to generate a first prompt for creating content related to the first plurality of objects in response to the input of a third gesture for content creation.

The first prompt generation request may include first data related to the first plurality of objects. For example, if the first plurality of objects includes graphic objects representing images and graphic objects representing text, the first prompt generation request may include image data and text data.

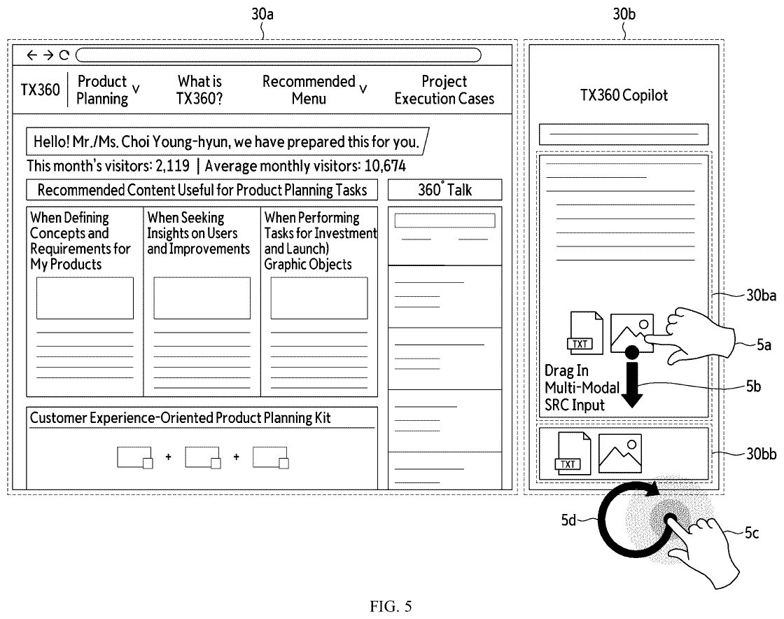

In one embodiment, the third gesture for content creation may include the user's long-tap input and counterclockwise or clockwise drag input. For example, as illustrated in FIG. 5, the third gesture for content creation may comprise the user's long-tap input 5c and counterclockwise drag input 5d performed while maintaining the long-tap input 5c. Here, the third gesture may be input within the prompt input area 30b.

It should be noted that the third gesture for content creation described above is merely exemplary and encompasses various other predefined gestures set by the user for content creation.

In step S13, the computing device (i.e., the user terminal) may receive first content created by generative AI based on the first prompt input through the service server. In step S14, the computing device (i.e., the user terminal) may display the first content on the screen.

Here, the generative AI may be an AI model that receives a text prompt and outputs content in the form of images, text, audio content, or video content. Additionally, the generative AI may be an AI model that receives a prompt combining one or more of images, text, audio, and video data and outputs content that combines various attributes of data. In other words, the data attributes included in the prompt input to the generative AI and the data attributes of the content output by the generative AI may not necessarily be identical. Furthermore, the generative AI may be an AI model capable of creating the desired content, selected according to the user's needs.

When the first content is displayed, the first prompt containing information on the first plurality of objects may be displayed on the screen of the computing device (i.e., the user terminal) along with the first content. For example, the first prompt displaying the plurality of graphic objects selected by the user through the first gesture may be displayed on the screen of the user terminal along with the first content.

In some embodiments, the first content may be displayed within the prompt input area of the content creation screen or in a separate pop-up window within the content creation screen.

Referring first to FIG. 3, when the first content is displayed within the prompt input area 30b of the content creation screen, the first content may be displayed in the first area 30ba of the prompt input area 30b, where prompts completed by the user can be displayed. Specifically, the first content may be displayed in part of the first area 30ba closest to the second area 30bb, where prompts being entered by the user can be displayed.

For example, the first content created based on the first prompt (i.e., including a plurality of graphic objects) recently input by the user may be displayed immediately below the area where the first prompt is displayed, and the area where the user can input new prompts may be displayed immediately below the area where the first content is displayed.

Thereafter, when the first content is displayed in a separate pop-up window within the content creation screen, the first content may be displayed in any area within the content creation screen. In this case, the area where the user can input new prompts may be displayed immediately below the area where the first prompt (i.e., including a plurality of graphic objects) recently input by the user is displayed, and the first content created based on the first prompt may be displayed in any area on the screen of the user terminal.

Thus far, the processes of selecting a plurality of objects at once, generating and displaying a prompt based on the selected objects, and creating content related to the plurality of objects by inputting the prompt to a generative AI model have been explained with reference to steps S10 through S14 of the content creation screen provision method according to an embodiment of the present disclosure.

According to some embodiments regarding steps S10 through S14, the user can select a plurality of objects containing various attributes of data at once through a predefined gesture, and optimal content that best meets the user's needs can be created through integration with the generative AI, thereby effectively improving user convenience and satisfaction.

A process that allows the user to easily and directly edit the previously-generated prompt if the first content does not meet the user's expectations will hereinafter be described with reference to steps S15 through S19.

In step S15, the computing device (i.e., the user terminal) may receive a predefined second gesture for at least one object among the first plurality of objects displayed in the prompt input area. Specifically, the first plurality of objects may be displayed in the area where previously input prompts are displayed in the prompt input area. In step S16, the computing device (i.e., the user terminal) may display a second plurality of objects determined according to the second gesture in the prompt input area on the screen.

Here, the first plurality of objects may refer to graphic objects referenced for creating the first content, and the second plurality of objects may refer to graphic objects referenced for editing the first content. That is, some graphic objects referenced for creating the first content may be excluded, some graphic objects referenced for creating the first content may be replaced with new graphic objects, or new graphic objects may be added to the graphic objects referenced for creating the first content.

The second gesture, which is applied within the prompt input area, may refer to various predefined gestures comprising one or more actions.

In one embodiment, the second gesture may include an action of moving a first object displayed in the prompt input area outside of the prompt input area while maintaining a long-tap input on the first object. In this case, data related to the first object may be deleted from the first prompt, thereby editing the first prompt into a second prompt.

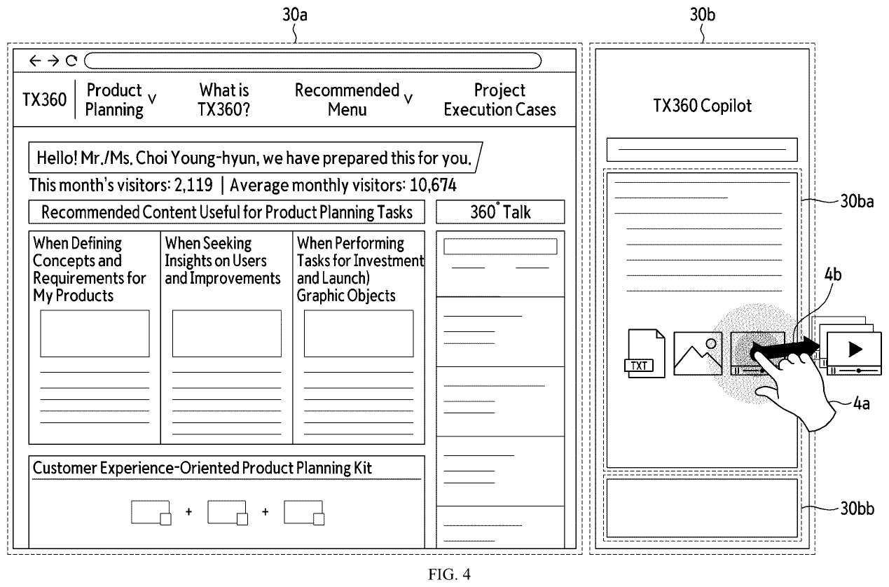

A second gesture according to some embodiments of the present disclosure will hereinafter be described with reference to FIG. 4. FIG. 4 is a diagram for explaining some operations (i.e., steps S15 and S16) illustrated in FIG. 1.

Referring to FIG. 4, the content creation screen displayed on the user terminal may include a web page area 30a that displays various data referenced for creating the desired content and a prompt input area 30b where prompts for creating the desired content may be entered.

The prompt input area 30b may include a first area 30ba where completed prompts are displayed and a second area 30bb where prompts being entered by the user are displayed. Specifically, the first area 30ba may display prompts that have been completed and input to a generative AI model through a service server. On the other hand, the second area 30bb may display prompts currently being entered by the user, yet to be sent to the service server or input to the generative AI.

As illustrated in FIG. 4, the second gesture may involve predefined actions of performing a long-tap input 4a on a first object among a first plurality of objects displayed in the first area 30ba of the prompt input area 30b, and moving the first object out of the first area 30ba by performing a drag input on the first object while maintaining the long-tap input 4a on the first object. In response to the second gesture, a second plurality of objects obtained by excluding the first object 4a from the first plurality of objects may be displayed in the second area 30bb of the prompt input area 30b.

In one embodiment, the second gesture may include an action of moving a first object displayed in the prompt input area out of the prompt input area while maintaining a long-tap input on the first object, and an action of moving a second object with the same attribute as the first object into the prompt input area while maintaining a long-tap input on the second object. Here, the second object may be a graphic object displayed outside the prompt input area. In this case, data regarding the first object in the first prompt may be replaced with data regarding the second object, thereby editing the first prompt into the second prompt.

Although not illustrated in FIG. 4, the second gesture may involve predefined actions of performing a long-tap input 4a on a first object among a plurality of objects displayed in the first area 30ba of the prompt input area 30b, moving the first object out of the first area 30ba by performing a drag input 4b on the first object out of the first area 30ba while maintaining the long-tap input 4a on the first object, performing a long-tap input on a second object (not illustrated) displayed in the web page area 30a, and dragging the second object into the second area 30bb of the prompt input area 30b while maintaining the long-tap input on the second object. In response to the second gesture, the second plurality of objects, obtained by excluding the first object 4a from the first plurality of objects and adding the second object, may be displayed in the second area 30bb of the prompt input area 30b.

A further explanation of the second gesture according to some embodiments of the present disclosure will now be provided with reference to FIG. 5. FIG. 5 is a diagram for explaining some operations (i.e., steps S15 and S16) illustrated in FIG. 1.

In one embodiment, the second gesture may include an action of moving a first object displayed in the first area within the prompt input area to the second area within the prompt input area while maintaining a long-tap input on the first object.

As illustrated in FIG. 5, the second gesture may include predefined actions of performing a long-tap input 5a on a first object among a first plurality of objects displayed in the first area 30ba of the prompt input area 30b and moving the first object into the second area 30bb by performing a drag input 5b on the first object while maintaining the long-tap input 4a on the first object. In response to the second gesture, a second plurality of objects, including the first object, may be displayed in the second area 30bb of the prompt input area 30b.

In one embodiment, the second gesture may include an action of moving a first object displayed in the first area of the prompt input area to the location of a second object while maintaining a long-tap input on the first object, and an action of moving the second object to the second area of the prompt input area while maintaining a long-tap input on the second object.

That is, although not illustrated in FIG. 5, the second gesture may involve predefined actions of performing a long-tap input 4a on a first object among a plurality of objects displayed in the first area 30ba of the prompt input area 30b, moving the first object to the location of a second object while maintaining the long-tap input 4a on the first object, performing a long-tap input on the second object, and dragging the second object into the second area while maintaining the long-tap input on the second object. In response to the second gesture, a second plurality of objects, including both the first and second objects, may be displayed in the second area 30bb of the prompt input area 30b.

In short, the second gesture may involve predefined actions that perform the same function as the first gesture explained earlier with reference to FIG. 3, which supports multi-selection and multi-input for a plurality of objects referenced for content creation. In other words, even during the editing of first content created by initial execution, the user can easily generate a prompt for editing the first content by selecting a plurality of objects referenced for creating the first content at once. Accordingly, user convenience and satisfaction can be enhanced.

It is to be understood that the second gesture is not limited to the examples illustrated in FIGS. 4 and 5. The second gesture may include various other predefined actions that allow the user to select multiple objects at once for content editing and insert the selected objects into the prompt input area.

Referring back to FIG. 1, in step S17, the computing device (i.e., the user terminal) may transmit a second prompt generation request to the service server to generate a second prompt for creating content related to the second plurality of objects in response to the input of a third gesture for content creation.

The second prompt generation request may include second data regarding the second plurality of objects. For example, if the second plurality of objects includes graphic objects representing images and videos, the second prompt generation request may include image data and video data.

In one embodiment, the third gesture for content creation may include the user's long-tap input and counterclockwise or clockwise drag input. However, it is to be understood that the aforementioned third gesture for content creation is merely exemplary and may also include various predefined gestures set by the user for transmitting the prompt for content creation to the service server.

The third gesture for content creation may not necessarily be identical to the third gesture in step S12. That is, in some embodiments, the gesture for initial content creation and the gesture for content editing may be set differently.

In step S18, the computing device (i.e., the user terminal) may receive second content created by the generative AI based on the second prompt input through the service server. In step S19, the computing device (i.e., the user terminal) may display the second content on the screen.

Here, the second content may differ from the initially created first content. That is, since the second content is created through a direct editing process in which the user changes at least some of the objects referenced for creating the first content, the second content may vary depending on the types and combinations of data corresponding to the objects referenced for creating the first content.

Here, the generative Al may differ from the generative AI in step S13. That is, since a generative AI model suitable for creating the user's desired content may vary depending on the types and combinations of data included in the prompt input by the user, the generative AI used for creating the first content and the generative AI used for creating the second content may be different AI models.

The type of generative AI model and the location where the second content is displayed have already been explained in the description for step S13, and thus, repetitive descriptions thereof will be omitted.

The regeneration of content when the initially created content does not meet the user's needs has been described so far with reference to steps S15 through S19 of the content creation screen provision method according to an embodiment of the present disclosure. Specifically, the user may edit a prompt by selecting at least some of the objects referenced for creating first content (i.e., content created through initial execution), and may re-create content related to the selected objects by inputting the edited prompt to the generative AI.

According to some embodiments regarding steps S15 through S19, the user may edit a prompt by excluding some of the objects referenced for creating first content, replacing them with new objects, or adding new objects. That is, fine-tuned edits can be made to the existing prompt at the level of objects, increasing the likelihood of creating optimal content that meets the user's needs. Furthermore, during the editing of the prompt, multiple objects can be selected and input at once within a single screen for content re-creation, effectively enhancing user convenience and satisfaction.

In some embodiments of the present disclosure, during the regeneration of content that meets the user's needs, edits or adjustments may be performed at the level of content rather than at the level of objects referenced for content creation.

In one embodiment, after displaying the second content on the screen in step S19, the content creation screen provision method according to an embodiment of the present disclosure may further include receiving, by the computing device (i.e., the user terminal), a predefined fourth gesture for the second content and, in response to the fourth gesture, transmitting a third prompt generation request to the service server to generate a third prompt. The third prompt generation request may include second data regarding the second content and user edit request data for the second content.

Additionally, the fourth gesture may be applied within the prompt input area or within the area where the second content is displayed.

In one embodiment, when the second content is displayed within the prompt input area, the fourth gesture may be applied within the second content displayed in the prompt input area. For example, if the user is dissatisfied with a particular part (e.g., image content) of the second content, the user may specify part of the second content to be edited through a predefined fourth gesture (e.g., a double-tap input, check mark input, or circle-drawing input), and based on this, the regeneration of a prompt and content by the generative AI may be performed.

In one embodiment, if the second content is displayed in a separate pop-up window within the content creation screen, the fourth gesture may be applied within the second content displayed in the pop-up window.

It is to be understood that the fourth gesture is not limited to the aforementioned examples. That is, the user's fourth gesture may include various predefined actions for specifying part of content to be edited.

The secondary content re-creation process performed in response to the fourth gesture may be distinguished from the primary content re-creation process described with reference to steps S15 through S19. In other words, the primary content re-creation process may be understood as allowing primary minute edits to a previously-generated prompt at the level of objects referenced for content creation, while the secondary content re-creation process may be understood as allowing secondary edits at the level of the content itself, rather than at the level of individual objects. Therefore, by selectively providing a prompt edit function at different levels during content re-creation, optimal content that better meets the user's needs can be created. Additionally, by providing a content edit function through a predefined gesture that minimizes the user's manipulations, user convenience and satisfaction can be effectively enhanced.

In the process of generating a prompt for creating the desired content or for editing previously-created content, there may be limitations in creating the desired content or satisfying the user's editing needs by relying solely on gestures for a plurality of objects. Therefore, according to some embodiments of the present disclosure, a text-or voice-based user request may be received before transmitting a prompt generation request for content creation or editing to the service server.

In one embodiment, before transmitting the first prompt generation request to the service server in step S12, the content creation screen provision method according to an embodiment of the present disclosure may further include receiving a user request for content creation. In this case, the first prompt generation request may include data from the user request (e.g., text or voice data containing the details of the content desired by the user).

In one embodiment, before transmitting the second prompt generation request to the service server in step S17, the content creation screen provision method according to an embodiment of the present disclosure may further include receiving a user request for content editing. In this case, the second prompt generation request may include data from the user request (e.g., text or voice data containing the user's content edit requirements).

According to the present embodiment, a prompt can be generated by reflecting both the user's gesture data and requirement data, and based on the generated prompt, the generative AI may create or edit content.

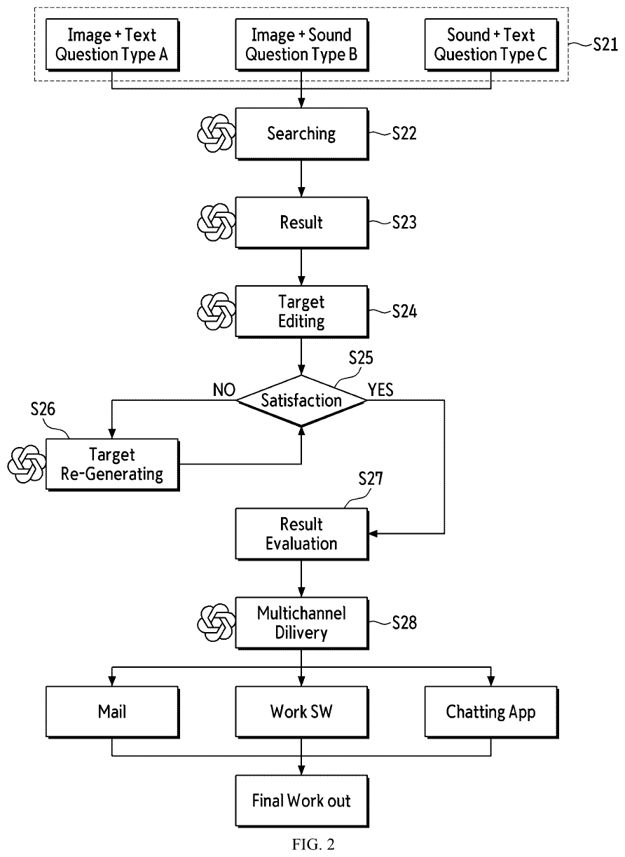

The overall processes of the content creation screen provision method according to an embodiment of the present disclosure will hereinafter be briefly summarized with reference to FIG. 2.

FIG. 2 is an exemplary flowchart illustrating a content creation screen provision method according to some embodiments of the present disclosure. However, it is to be understood that the embodiment of FIG. 2 is merely a preferred embodiment for achieving the objectives of the present disclosure, and certain steps may be added or deleted as needed.

As illustrated in FIG. 2, the content creation screen provision method according to some embodiments of the present disclosure may start with step S21, in which a user inputs a user request comprising a combination of a plurality of data (e.g., image+text, image+audio, audio+text) into the user terminal. The plurality of data may refer to data corresponding to objects selected by the user from among a plurality of objects displayed on a content creation screen. Step S21 corresponds to steps S10 and S11 of FIG. 1, as explained with reference to FIG. 3, and thus, redundant explanations thereof will be omitted.

In step S22, storage paths for image, text, audio, and video data entered by the user for prompt generation may be searched, and based on the retrieved paths, a prompt generation request may be transmitted to a service server. In step S23, the service server may generate a prompt, input the prompt to a generative AI model, receive content created based on the data entered by the user from the generative AI, and then transmit the content to the user terminal. Thereafter, the user terminal may display the received content on the screen. Steps S22 and S23 correspond to steps S12 through S14 of FIG. 1, and thus, redundant explanations thereof will be omitted.

In step S24, the user may review the received content and select some objects from among a plurality of objects used for the generation of the content as target objects for editing. Thereafter, in response to the user's predefined gesture for the target objects, an edited prompt may be generated and input to the generative AI, and content may be re-created by the generative AI. Step S24 corresponds to the process of re-creating or editing content at the object level and corresponds to steps S15 through S19 of FIG. 1, and thus, redundant explanations thereof will be omitted.

In step S25, the user may review the content re-created or edited in step S24, and if dissatisfied with the edited content, the user may re-create the content through step S26. Step S26 may refer to the process of re-creating or editing content at the content level, rather than at the object level. Additionally, in step S27, if the user is satisfied with the content re-created or edited through step S24, the user may input information such as satisfaction ratings, evaluation scores, and feedback for the edited content. The input information may later be used to generate content that meets the user's needs or improve the overall quality of the content creation screen provision service.

Lastly, in step S28, the user may transmit the finally created content to various applications, such as chat applications, email, and work-related programs, for various purposes.

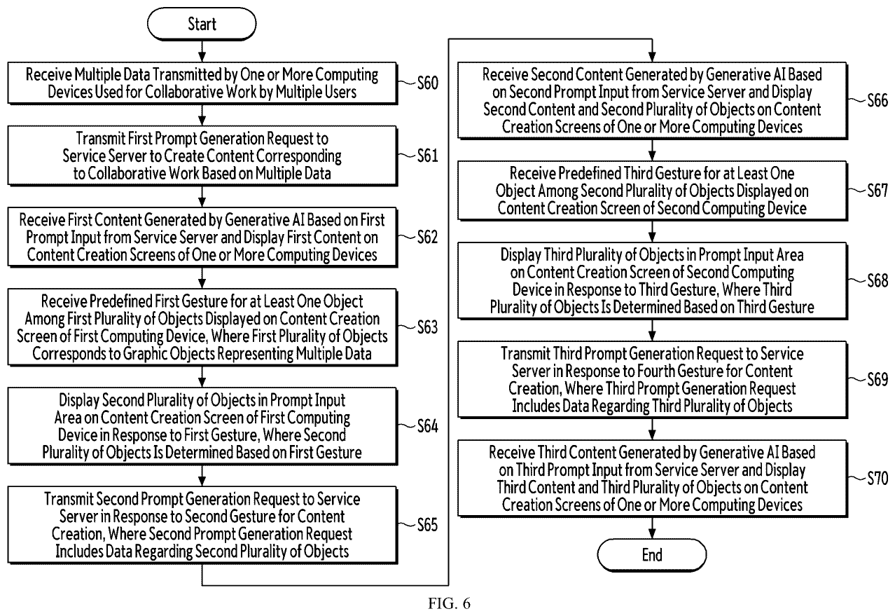

Thus far, a content creation screen provision method for a single user according to some embodiments of the present disclosure have been explained with reference to FIGS. 1 through 5. However, in collaborative work performed by multiple users, a content creation screen needs to be provided to multiple users, and each user may need to perform a content creation or editing task. A content creation screen provision method for collaborative work involving multiple users will hereinafter be described with reference to FIGS. 6 through 8.

FIG. 6 is a flowchart illustrating a content creation screen provision method according to another embodiment of the present disclosure. However, it is to be understood that the embodiment of FIG. 6 is merely a preferred embodiment for achieving the objectives of the present disclosure, and certain steps may be added or deleted as needed.

FIG. 6 illustrates steps/operations of a method performed by multiple user terminals (i.e., computing devices). Therefore, in the following description, if the subject performing a particular step/operation is not specified, it may be understood that the particular step/operation is performed by at least one of the multiple user terminals.

Here, the user terminals may be devices such as mobile phones, smartphones, tablets, laptop PCs, or desktop PCs. For case of understanding, the following description assumes that each of the user terminals is a smartphone, and that the content creation screen provided to each user is the screen of the smartphone.

Processes to be described with reference to FIGS. 6 through 8 differ from those described with reference to FIGS. 1 through 5 in that they are based on gestures input by multiple users into their respective user terminals, rather than a single user. That is, except that there are multiple users and that the objects targeted by the users' input gestures differ, the steps/operations illustrated in FIG. 6 are identical or similar to those illustrated in FIG. 1. Therefore, any redundant explanations will be omitted, and the focus will be on explaining the differences.

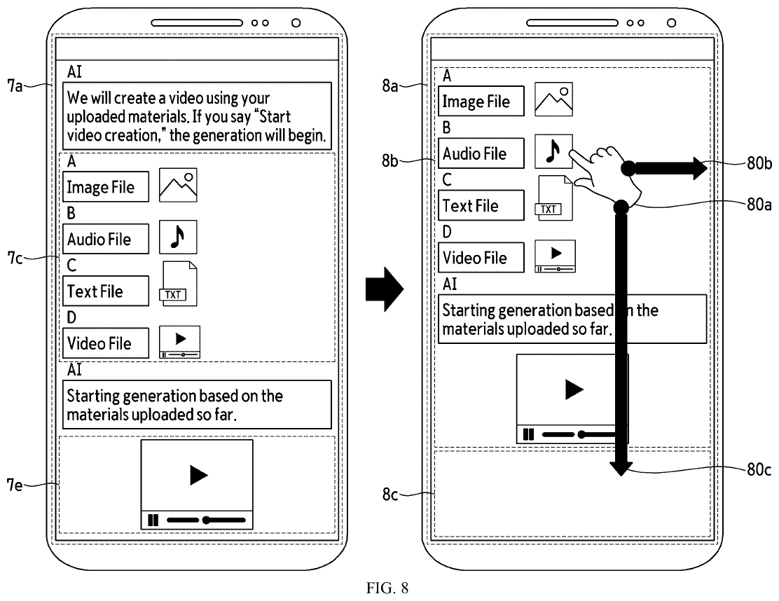

As illustrated in FIG. 6, the content creation screen provision method according to another embodiment of the present disclosure may start with step S60, in which multiple data transmitted by one or more computing devices (i.e., user terminals) used for collaborative work by multiple users are received. At this time, the multiple data may include files containing images, videos, text, and audio materials, and the files may be displayed as visualized graphic objects on the screens of the one or more computing devices. Detailed descriptions regarding this will be provided later with reference to FIG. 8.

In step S61, the one or more computing devices may transmit a first prompt generation request to a service server to create content corresponding to the collaborative work based on the multiple data. In step S62, the one or more computing devices may receive first content created by a generative AI model based on a first prompt input from the service server and display the first content on the content creation screens of the one or more computing devices.

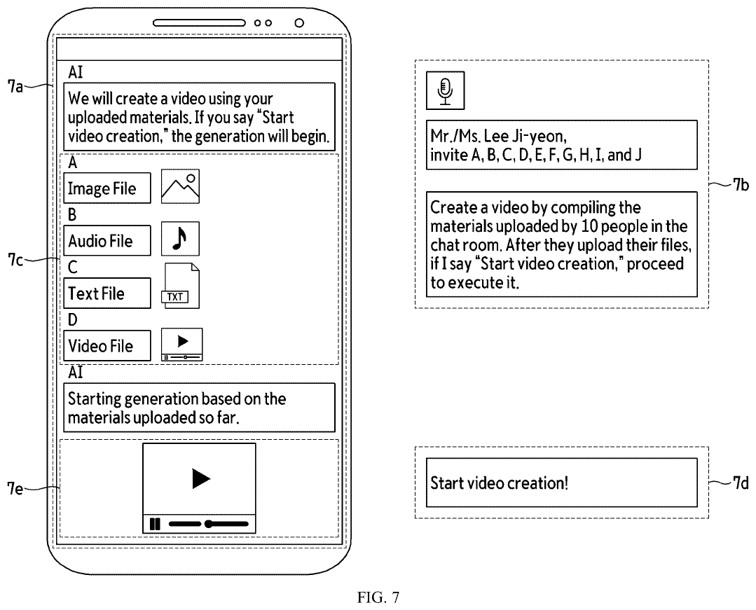

Detailed explanations of some operations (i.e., steps S60 through S62) illustrated in FIG. 6 will now be provided with reference to FIG. 7. FIG. 7 illustrates an exemplary screen of a user terminal, explaining the process of generating content through collaboration by multiple users.

Referring to a screen 7a of a user terminal in FIG. 7, the user (i.e., the leader or project manager of a team comprising multiple users) may input voice data 7b into the user terminal to provide guidance or a request regarding content to be created through collaborative work. For example, the guidance or request may involve inviting the multiple users to a chat room to collaborate and create video content that compiles materials uploaded by the multiple users. Additionally, the user may arbitrarily designate the start time for playing the video content.

In response to the user entering voice data 7b, a system message indicating the start of video content creation may be displayed in the chat room, and files 7c containing various attributes of data (e.g., images, audio, text, or videos) may be uploaded to the chat room from the user terminals of the multiple users participating in the collaborative work.

Each user may upload data (e.g., files) referenced for generating the video content to the chat room from their respective user terminals, and the uploaded files may be displayed as graphic objects in the chat room. Once all the multiple users complete the file upload, the user may input voice data 7d indicating the start of video creation, and a prompt generation request may be transmitted to the service server. Thereafter, a system message indicating the start of video content creation may be displayed in the chat room, and video content 7e generated by the generative AI based on the prompt input from the service server may be displayed within the chat room on the screens of the user terminals of the multiple users.

The process in which the multiple users transmit data (e.g., files) referenced for generating video content to the chat room from their respective user terminals may include the steps/operations explained earlier with reference to FIGS. 1 through 3. Specifically, if the user terminals are desktop PCs, the multiple users may transmit files or materials combining different attributes of data to the chat room by performing multi-selection and multi-input gestures for objects displayed on the content creation screens of their respective user terminals.

Referring back to FIG. 6, in step S63, a first computing device may receive a predefined first gesture for at least one object among a first plurality of objects displayed on the content creation screen of the first computing device. Here, the first computing device may be the user terminal of a first user among multiple users participating in the collaborative work. Additionally, the first plurality of objects may correspond to graphic objects representing the multiple data.

In step S64, the first computing device may display a second plurality of objects, determined based on the first gesture, in the prompt input area on the content creation screen of the first computing device in response to the first gesture. In step S65, the first computing device may transmit a second prompt generation request to the service server in response to the input of a second gesture for content creation. The second prompt generation request may include data regarding the second plurality of objects.

In step S66, the first computing device may receive second content generated by the generative AI based on a second prompt input from the service server, and may display the second content and the second plurality of objects on the content creation screens of the one or more computing devices.

Detailed explanations of some operations (i.e., steps S63 through S66) illustrated in FIG. 6 will now be provided with reference to FIG. 8. FIG. 8 illustrates an exemplary screen of a user terminal (i.e., a smartphone), explaining the process of generating a prompt for content editing by a first computing device of a first user.

If an initially generated video content 7e does not meet the user's needs or predefined deliverable criteria, the user may edit the video content 7e through a predefined gesture for a plurality of objects referenced for generating the video content 7e.

For example, referring to a screen 8a of the user terminal (e.g., smartphone) of the first user in FIG. 8, the first user may perform a tap input 80a for one object among a plurality of objects displayed on a content creation screen 8b, and move the one object out of the content creation screen 8b by performing a drag input 80b while maintaining the tap input 80a. Through this, a prompt excluding data of the one object may be generated, and new video content generated without using the data of the one object may be provided based on the prompt.

In another example, the first user may perform a tap input 80a for one object among the plurality of objects displayed on the content creation screen 8b, and move the object to a prompt input area 8c by performing a drag input 80c while maintaining the tap input 8a. Through this, a prompt including only data of the object may be generated, and new video content generated using only the data of the one object may be provided based on the prompt.

Steps S63 through S66 are similar to the steps/operations of the object-level content editing process explained earlier with reference to FIGS. 1, 4, and 5, and thus, any redundant explanations (i.e., the meaning of the first and second gestures) will be omitted.

Referring back to FIG. 6, in step S67, a second computing device may receive a predefined third gesture for at least one object among a second plurality of objects displayed on the content creation screen of the second computing device. Here, the second computing device may be the terminal of a second user who is different from the first user among the multiple users participating in the collaborative work.

In step S68, the second computing device may display a third plurality of objects, determined based on the third gesture, in the prompt input area on the content creation screen of the second computing device in response to the third gesture. In step S69, the second computing device may transmit a third prompt generation request to the service server in response to the input of a fourth gesture for content creation. The third prompt generation request may include data regarding the third plurality of objects.

In step S70, the second computing device may receive third content generated by the generative AI based on a third prompt input from the service server and display the third content and the third plurality of objects on the content creation screens of the one or more computing devices.

Steps S67 through S70 are similar to the steps/operations of the object-level content editing process explained earlier with reference to FIGS. 1, 4, and 5, and thus, any redundant explanations (i.e., the meaning of the third and fourth gestures) will be omitted.

Additionally, as explained earlier with reference to FIGS. 1, 4, and 5, during the re-creation of content that meets the user's needs, editing or modification may be performed at the content level rather than at the object level. That is, a third user may perform content-level editing by inputting a predefined fourth gesture for the third content generated in step S70. The fourth gesture may be applied within the area displayed on the screen of the third user's terminal. The content-level editing or modification process has already been explained in detail with reference to FIGS. 1, 4, and 5, and thus, any redundant explanations will be omitted.

During the collaborative work by the multiple users using the generative AI, a situation may arise where finding and editing prompts becomes difficult due to the accumulation of prompts input by each user.

In one embodiment, in response to the user entering a predefined gesture, a pop-up window displaying summary information on the prompts input by the multiple users and the types or attributes of data included in the input prompts may be displayed adjacent to the prompt input area. If the user selects a first prompt from among the input prompts displayed in the pop-up window, the first prompt may be displayed in part of the prompt input area where the most recently input prompt is displayed.

In one embodiment, based on voice data input by the user, the prompt that the user wishes to edit or the most similar prompt may be displayed. For example, if the user inputs guide voice data saying, “Revert to the state before the second edit,” a prompt requesting the second edit may be displayed in the part of the prompt input area where the most recently input prompt is displayed. Additionally, if the user inputs guide voice data saying, “Revert to the state before user B's edit,” the prompt before user B's edit may be displayed in the part of the prompt input area where the most recently input prompt is displayed.

In short, during the collaborative work by the multiple users, the multiple users may input a predefined gesture into their respective user terminals to select a plurality of graphic objects containing various attributes of data displayed on the content creation screen (e.g., a web page screen) at once and move the selected graphic objects to the prompt input area. Through the predefined gesture, a prompt for creating content related to the selected graphic objects may be generated.

Additionally, during the editing of previously generated content, each user may easily generate a prompt for editing the content by selecting at least some of the objects referenced for generating the content at once. Furthermore, each user may selectively perform an object-level or content-level prompt editing process as needed.

Accordingly, optimal content that meets the user's needs may be generated, and user convenience and satisfaction can be effectively enhanced.

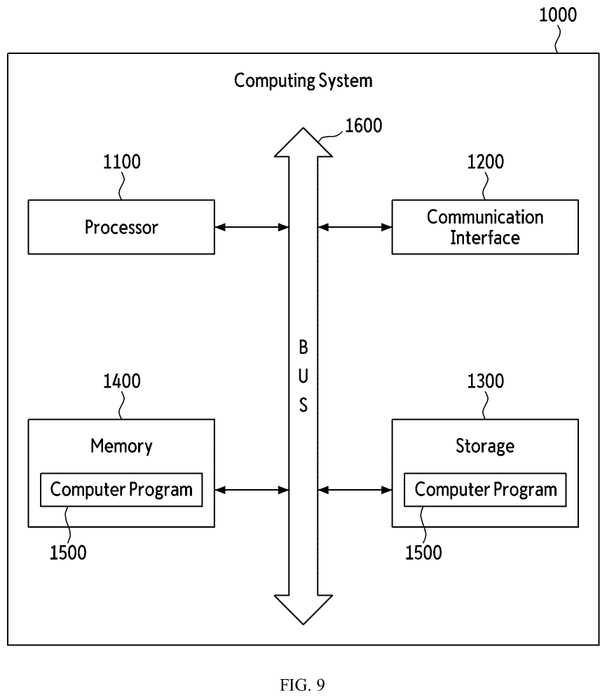

An exemplary the content creation screen provision system capable of a content creation screen provision system according to some embodiments of the present disclosure will hereinafter be described with reference to FIG. 9.

FIG. 9 is an exemplary hardware configuration diagram of the content creation screen provision system 1000.

Referring to FIG. 9, the content creation screen provision system 1000 may include at least one processor 1100, a system bus 1600, a communication interface 1200, a memory 1400 that loads a computer program 1500 executed by the processor 1100, and a storage 1300 that stores the computer program 1500.

The processor 1100 controls the overall operation of each component of the content creation screen provision system 1000. The processor 1100 may perform calculation for at least one application or program for executing methods/operations according to various embodiments of the present disclosure. The memory 1400 stores various data, commands, and/or information. The memory 1400 may load at least one computer program 1500 from the storage 1300 to execute the methods/operations according to various embodiments of the present disclosure. The storage 1300 may non-transitorily store the computer program 1500. The computer program 1500 may include one or more instructions implementing the methods/operations according to various embodiments of the present disclosure. When the computer program 1500 is loaded into the memory 1400, the processor 1100 may execute the one or more instructions to perform the methods/operations according to various embodiments of the present disclosure.

In some embodiments, the computing system 1000 may be configured using one or more physical servers in a server farm based on a cloud technology such as virtual machines. In this case, some of the processor 1100, the memory 1400, and the storage 1300 may be virtual hardware, and the communication interface 1200 may also be implemented as a virtualized networking element such as a virtual switch.

So far, a variety of embodiments of the present disclosure and the effects according to embodiments thereof have been mentioned with reference to FIGS. 1 to 9. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A content creation screen provision method performed by a computing device, comprising:
receiving a predefined first gesture for a first plurality of objects displayed on a content creation screen of the computing device;
displaying the first plurality of objects in a prompt input area on the content creation screen in response to the first gesture;
transmitting, to a service server, a first prompt generation request for creating content related to the first plurality of objects in response to a third gesture for content creation, wherein the first prompt generation request includes first data regarding the first plurality of objects;
receiving first content generated by generative artificial intelligence (AI) based on a first prompt input from the service server;
displaying the first content on the content creation screen;
receiving a predefined second gesture for at least one object among the first plurality of objects displayed in the prompt input area, wherein the second gesture is applied within the prompt input area;
displaying a second plurality of objects in the prompt input area on the content creation screen in response to the second gesture, wherein the second plurality of objects is determined based on the second gesture;
transmitting, to the service server, a second prompt generation request in response to the third gesture, wherein the second prompt generation request includes second data regarding the second plurality of objects;
receiving second content generated by the generative AI based on a second prompt input from the service server; and
displaying the second content on the content creation screen.

2. The content creation screen provision method of claim 1, wherein the first plurality of objects includes graphic objects representing images, videos, text, and audio information.

3. The content creation screen provision method of claim 1, wherein the first gesture includes: an action of moving a first object to a location of a second object while maintaining a first long-tap input on the first object; an action of moving the second object to the prompt input area while maintaining a second long-tap input on the second object; and an action of releasing the second long-tap input in the prompt input area.

4. The content creation screen provision method of claim 3, wherein the first and second objects are graphic objects representing different attributes of information.

5. The content creation screen provision method of claim 3, further comprising:
before the transmitting the first prompt generation request to the service server, receiving a user request related to content creation,
wherein the first prompt generation request further includes data regarding the user request.

6. The content creation screen provision method of claim 1, wherein the second gesture includes an action of moving a first object out of the prompt input area while maintaining a long-tap input on the first object.

7. The content creation screen provision method of claim 6, wherein
the second gesture further includes an action of moving a second object with a same attribute as the first object into the prompt input area while maintaining a long-tap input on the second object, and
the second object is a graphic object displayed outside the prompt input area.

8. The content creation screen provision method of claim 1, wherein
the second gesture includes: an action of moving a first object to a location of a second object while maintaining a first long-tap input on the first object in a first area within the prompt input area; and an action of moving the second object to a second area within the prompt input area while maintaining a second long-tap input on the second object, and
the first and second areas are displayed at different locations.

9. The content creation screen provision method of claim 1, further comprising:
after the displaying the second content on the content creation screen, receiving a predefined fourth gesture for the second content; and
transmitting, to the service server, a third prompt generation request in response to the fourth gesture, wherein the third prompt generation request includes second data regarding the second content and user edit request data regarding the second content.

10. The content creation screen provision method of claim 9, wherein the fourth gesture is applied within an area on the content creation screen where the second content is displayed.

11. A content creation screen provision method performed by one or more computing devices, comprising:
receiving multiple data transmitted by the one or more computing devices used for collaborative work by multiple users;
transmitting, to a service server, a first prompt generation request for creating content corresponding to the collaborative work based on the multiple data;
receiving first content generated by generative artificial intelligence (AI) based on a first prompt input from the service server and displaying the first content on content creation screens of the one or more computing devices;
receiving, by a first computing device, a predefined first gesture for at least one object among a first plurality of objects displayed on a content creation screen of the first computing device, wherein the first plurality of objects corresponds to graphic objects representing the multiple data;
displaying, by the first computing device, a second plurality of objects in a prompt input area on the content creation screen of the first computing device in response to the first gesture, wherein the second plurality of objects is determined based on the first gesture;
transmitting, to the service server, a second prompt generation request in response to a second gesture for content creation, wherein the second prompt generation request includes data regarding the second plurality of objects;
receiving second content generated by the generative AI based on a second prompt input from the service server and displaying the second content and the second plurality of objects on the content creation screens of the one or more computing devices;
receiving, by a second computing device, a predefined third gesture for at least one object among the second plurality of objects displayed on a content creation screen of the second computing device;
displaying, by the second computing device, a third plurality of objects in a prompt input area on the content creation screen of the second computing device in response to the third gesture, wherein the third plurality of objects is determined based on the third gesture;
transmitting, to the service server, a third prompt generation request in response to the second gesture for content creation, wherein the third prompt generation request includes data regarding the third plurality of objects; and
receiving third content generated by the generative AI based on a third prompt input from the service server and displaying the third content and the third plurality of objects on the content creation screens of the one or more computing devices.

12. The content creation screen provision method of claim 11, wherein
the multiple data includes files in which image, video, text, and audio materials are stored, and
the files are displayed as visualized graphic objects on screens of the one or more computing devices.

13. The content creation screen provision method of claim 12, wherein the first gesture includes an action of moving a first object out of the prompt input area on the content creation screen of the first computing device while maintaining a long-tap input on the first object.

14. The content creation screen provision method of claim 13, wherein the first gesture further includes an action of moving a second object with a same attribute as the first object into the prompt input area while maintaining a long-tap input on the second object.

15. The content creation screen provision method of claim 12, further comprising:
after the displaying the third content and the third plurality of objects on the content creation screens of the one or more computing devices, receiving a predefined fourth gesture for the third content displayed on a content creation screen of a third computing device; and
transmitting, to the service server, a fourth prompt generation request in response to the fourth gesture, wherein the fourth prompt generation request includes third data regarding the third content and user edit request data regarding the third content.

16. The content creation screen provision method of claim 15, wherein the fourth gesture is applied within an area on the content creation screen of the third computing device where the third content is displayed.

17. A content creation screen provision system comprising:
one or more processors; and
a memory storing one or more computer programs executed by the one or more processors,
wherein the one or more computer programs include instructions for operations of: receiving a predefined first gesture for a first plurality of objects displayed on a content creation screen of a computing device; displaying the first plurality of objects in a prompt input area on the content creation screen in response to an input of the first gesture;
transmitting, to a service server, a first prompt generation request for creating content related to the first plurality of objects in response to a third gesture for content creation, wherein the first prompt generation request includes first data regarding the first plurality of objects;
receiving first content generated by generative artificial intelligence (AI) based on a first prompt input from the service server; displaying the first content on the content creation screen; receiving a predefined second gesture for at least one object among the first plurality of objects displayed in the prompt input area, wherein the second gesture is applied within the prompt input area; displaying a second plurality of objects in the prompt input area on the content creation screen in response to an input of the second gesture, wherein the second plurality of objects is determined based on the second gesture; transmitting, to the service server, a second prompt generation request in response to the third gesture for content creation, wherein the second prompt generation request includes second data regarding the second plurality of objects; receiving second content generated by the generative AI based on a second prompt input from the service server; and displaying the second content on the content creation screen.
